(19) United States
(12) Patent Application Publication
(10) Pub. No.: US 2026/0155146 A1
(43) Pub. Date: Jun. 4, 2026

(54) AI VOICE INTERACTION CD PLAYER CONTROL METHOD AND DEVICE

(71) Applicant: Shenzhen Zhonglin Information Technology Co., Ltd., Shenzhen City (CN)

(72) Inventor: Weibing Hong, Shenzhen City (CN)

(73) Assignee: Shenzhen Zhonglin Information Technology Co., Ltd., Shenzhen City (CN)

(21) Appl. No.: 19/459,908

(22) Filed: Jan. 26, 2026

Related U.S. Application Data
(63) Continuation-in-part of application No. 18/920,361, filed on Oct. 18, 2024.

(51) Int. Cl. G10L 15/22; G06F 3/16; G10L 15/02; G10L 21/0208; G10L 25/24; G11B 19/02

(52) U.S. Cl. CPC G10L 15/22; G06F 3/162; G06F 3/165; G10L 15/02; G10L 21/0208; G10L 25/24; G11B 19/027; G10L 2015/223

(57) ABSTRACT

An AI voice interaction CD player control method and device. The method comprises the following steps: calling a microphone for an AI voice recognition module to collect the user's voice signal, and digitizing the collected voice signal into a digital audio signal; preprocessing the digital audio signal; extracting voice signal feature parameters for the preprocessed digital audio signal; the voice signal feature parameters include Mel-frequency cepstral coefficient feature vectors and represent the acoustic features of the voice signal; inputting the extracted voice signal feature parameters into a pre-trained voice recognition model built based on a deep learning algorithm, and classifying and recognizing the input voice signal feature parameters through the voice recognition model to generate text control commands for a CD player. The invention can accurately understand the user's voice commands, and automatically perform playback control and music recommendation based on the user's personalized needs and preferences.

### CROSS-REFERENCE TO RELATED APPLICATIONS

This application is a Continuation in part of the U.S. application Ser, No. 18920361 filed on Oct. 18, 2024, the entire disclosures of which are incorporated herein by reference.

### TECHNICAL FIELD

The invention relates to an AI voice interaction CD player control method and device, belonging to the technical field of players.

### BACKGROUND ART

CD player, also known as laser CD player, is an intelligent high-fidelity stereo audio device controlled by a microcomputer. It utilizes advanced laser technology, digital technology, computer technology, and various new components, offering advantages such as high-density recording, long playback time, user-friendly operation, and quick track selection. It realistically reproduces the recorded content with clear gradation and a strong sense of immersion.

Traditional CD players mainly rely on the physical buttons on the body for operation. Users need to manually control functions such as play, pause, track selection, and volume adjustment. This mode of operation is inconvenient in many scenarios. For example, when users are occupied with other tasks or are at a distance from the players, precise operation becomes difficult. Moreover, traditional CD players lack intelligence. They cannot understand voice commands or automatically adjust playback and recommend music based on users' personalized needs and preferences, making it challenging to meet modern users' demands for convenient, intelligent and personalized audio experiences.

### SUMMARY OF THE INVENTION

Therefore, the invention provides an AI voice interaction CD player control method and device, addressing the issues that traditional CD players lack intelligence, cannot understand users' voice commands and fail to meet users' personalized audio experience needs.

To achieve the above objectives, the invention provides the following technical solution: an AI voice interaction CD player control method, comprising the following steps:
calling a microphone for an AI voice recognition module to collect the user's voice signal, and digitizing the collected voice signal into a digital audio signal;
preprocessing the digital audio signal, including noise reduction, filtering and framing;
extracting voice signal feature parameters for the preprocessed digital audio signal; the voice signal feature parameters include Mel-frequency cepstral coefficient feature vectors and represent the acoustic features of the voice signal;
inputting the extracted voice signal feature parameters into a pre-trained voice recognition model built based on a deep learning algorithm, and classifying and recognizing the input voice signal feature parameters through the voice recognition model to generate text control commands for a CD player.

As a preferred embodiment of the AI voice interaction CD player control method, the preprocessing of the digital audio signal comprises the following steps:
defining an array to store the sample values of the digital audio signal;
the array format is int audioSamples[BUFFER_SIZE], where BUFFER_SIZE represents the size of the array for caching audio sample values;
using the sample value array of the digital audio signal and the array size as parameters, looping through the array, and calculating the average of the sample values within each window by taking a set window size as the unit;
building a nested loop, which includes an outer loop and an inner loop; controlling the sliding position of the window through the outer loop, and accumulating the sample values within the window and calculating the average through the inner loop; replacing the sample value at the central position of the window with the average.

As a preferred embodiment of the AI voice interaction CD player control method, the outer loop starts from half of the window size and ends at the array length minus half of the window size, so that each sample point to be filtered is positioned at the center of the window;
the window range of the inner loop is centered on the current outer loop position i, extending to the left and right by windowSize/2 sample points each, where windowSize is the window size for mean filtering.

As a preferred embodiment of the AI voice interaction CD player control method, in the voice recognition model built based on the deep learning algorithm, multiply the output value of the voice input signal by the corresponding weight and add them up, add the corresponding bias value of the voice output signal to the obtained result, and finally obtain the final output result of the voice output signal through an activation function.

As a preferred embodiment of the AI voice interaction CD player control method, the expression of the voice recognition model is as follows:

$$y ( n ) = Softmax ( {\sum }_{i = 1}^{n} {x}_{i} + {b}_{i} ) )$$

where y(n) represents the voice signal output by the model for the n^{th} type, wᵢ is the weight of the voice output signal i, xᵢ is the voice input signal i, and bᵢ is the bias value corresponding to the voice output signal i.

The invention also provides an AI voice interaction CD player control device, using the AI voice interaction CD player control method, and comprising a main control module, an AI voice recognition module, a CD player audio link module, an audio playback module and a storage module;
the AI voice recognition module comprises a voice recognition chip and a microphone, the microphone is electrically connected to the voice recognition chip, the voice recognition chip is electrically connected to the main control module, the voice recognition chip comprises an offline voice chip and an AI voice chip, and the AI voice recognition module is used to collect the user's voice control commands;
the CD audio link module comprises a disc drive mechanism, a driver chip and an audio decoder chip; the disc drive mechanism is connected to the driver chip, the driver chip is connected to the audio decoder chip 10, and the audio decoder chip is connected to the main control module; the disc drive mechanism is used to scan CD disc information via a laser head; the driver chip is used to read audio data; the audio decoder chip is used to decode and convert the read audio data into audio signals;
the audio playback module is connected to the main control module, is provided with an audio power amplifier chip and is used to play the original audio signals through the audio power amplifier chip and a speaker configured;
the storage module is connected to the main control module and is used for random access of audio signals obtained from decoded and converted audio data.

As a preferred embodiment, the AI voice interaction CD player control device further comprises a dual-mode wireless module, which is connected to the main control module and is used for wireless data transmission and control of the CD player.

As a preferred embodiment, the AI voice interaction CD player control device further comprises a mobile server module, which establishes a connection with the main control module through the dual-mode wireless module and enables users to send playback control commands to the CD player via a mobile terminal;
the mobile server module utilizes a trained voice recognition model based on a deep learning algorithm for comparison and matching, generates and transmits recognition results to the main control module; the main control module analyzes the recognition results and performs corresponding operations or displays based on the analysis results, thereby completing the interaction.

As a preferred embodiment, the AI voice interaction CD player control device further comprises a display module, which is equipped with a TFT color touch screen, is connected to the main control module and is used to display the music lyric data corresponding to the audio signals played.

As a preferred embodiment, the AI voice interaction CD player control device further comprises a power module, which is equipped with a battery, a 3.3V voltage regulator chip, a charging management chip and a charging interface;
the battery is used to supply power to the entire CD player; the charging interface is used to connect an external power adapter to charge the battery; the charging management chip is used to regulate the charging process; the 3.3V voltage regulator chip is used to convert the voltage input by the battery or the charging interface into a 3.3V voltage output to supply power to the entire CD player.

The invention has the following advantages: call a microphone for an AI voice recognition module to collect the user's voice signal, and digitize the collected voice signal into a digital audio signal; preprocess the digital audio signal, including noise reduction, filtering and framing; extract voice signal feature parameters for the preprocessed digital audio signal; the voice signal feature parameters include Mel-frequency cepstral coefficient feature vectors and represent the acoustic features of the voice signal; input the extracted voice signal feature parameters into a pre-trained voice recognition model built based on a deep learning algorithm, and classify and recognize the input voice signal feature parameters through the voice recognition model to generate text control commands for a CD player. The invention can accurately understand users' voice commands and automatically control playback and recommend music based on users' personalized needs and preferences, meeting their demands for convenient, intelligent and personalized audio experiences.

### BRIEF DESCRIPTION OF THE DRAWINGS

In order to more clearly describe the embodiments of the invention or the technical solutions in the prior art, the drawings required for describing the embodiments or the prior art will be briefly introduced below. It is evident that the drawings provided below are merely illustrative. Those skilled in the art may derive additional drawings from the provided drawings without creative effort.

The structure, scale, size, etc., illustrated in this specification are intended solely to complement the contents disclosed herein, facilitating understanding and reading by those skilled in the art. They are not meant to impose restrictive conditions on the implementation of the invention and therefore hold no technical substantive significance. Any modifications to the structure, adjustments to scale relationships, or changes in size shall fall within the scope of the technical content disclosed herein without affecting the intended effect and achievable objectives of the invention.

FIG. 1 is a flow diagram of the AI voice interaction CD player control method provided in the embodiment of the invention;

FIG. 2 is a flow diagram of the voice recognition in the AI voice interaction CD player control method provided in the embodiment of the invention;

FIG. 3 is a schematic diagram of voice signal processing by the voice recognition model in the AI voice interaction CD player control method provided in the embodiment of the invention;

FIG. 4 is a schematic diagram of the hardware architecture of the AI voice interaction CD player control device provided in the embodiment of the invention;

FIG. 5 is a schematic diagram of the power module in the AI voice interaction CD player control device provided in the embodiment of the invention.

Reference signs: 1. Main control module; 2. AI voice recognition module; 3. CD player audio link module; 4. Audio playback module; 5. Storage module; 6. Voice recognition chip; 7. Microphone; 8. Disc drive mechanism; 9. Driver chip; 10. Audio decoder chip; 11. Dual-mode wireless module; 12. Mobile server module; 13. Display module; 14. TFT color touch screen; 15. Power module; 16. Battery; 17. 3.3V voltage regulator chip; 18. Charging management chip; 19. Charging interface.

### DETAILED DESCRIPTION OF THE INVENTION

The embodiments of the invention are described below. Those skilled in the art can easily understand other advantages and effects of the invention from the contents disclosed in this specification. It is evident that the described embodiments represent part of the embodiments of the invention, not all of them. Based on the embodiments of the invention, all other embodiments obtained by those skilled in the art without creative effort shall fall within the scope of protection of the invention.

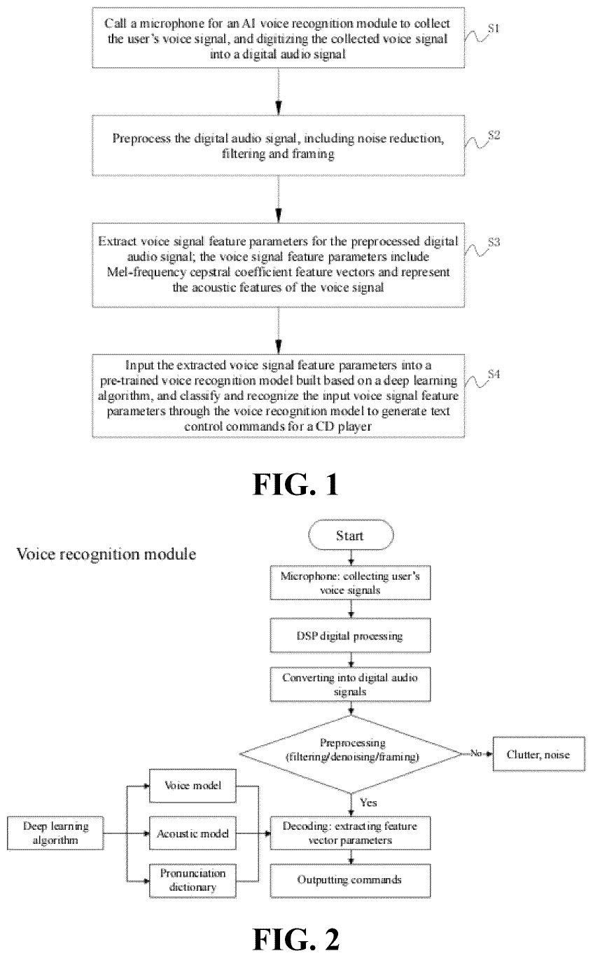

As shown in FIGS. 1 and 2, the embodiment of the invention provides an AI voice interaction CD player control method, comprising the following steps:
S1. calling a microphone for an AI voice recognition module to collect the user's voice signal, and digitizing the collected voice signal into a digital audio signal;
S2. preprocessing the digital audio signal, including noise reduction, filtering and framing;
S3. extracting voice signal feature parameters for the preprocessed digital audio signal; the voice signal feature parameters include Mel-frequency cepstral coefficient feature vectors and represent the acoustic features of the voice signal;
S4. inputting the extracted voice signal feature parameters into a pre-trained voice recognition model built based on a deep learning algorithm, and classifying and recognizing the input voice signal feature parameters through the voice recognition model to generate text control commands for a CD player.

In this embodiment, in S1, the AI voice recognition module collects the user's voice signals through the microphone, and digitally processes and converts them into digital audio signals. Next, in S2, preprocess the digital audio signals, including operations such as noise reduction, filtering and framing using a denoiser FM1288 chip, to enhance the quality and recognizability of the voice signals. In S3, extract the feature parameters of the voice signals, such as Mel-frequency cepstral coefficient (MFCC) and other feature vectors, which effectively represent the acoustic features of the voice signals. Subsequently, in S4, input the extracted feature vectors into the pre-trained voice recognition model, which is built based on the deep learning algorithms (such as deep neural networks, convolutional neural networks, or recurrent neural networks) and can classify and recognize the input feature vectors and output corresponding text commands through training of extensive voice data.

In this embodiment, in S2, the preprocessing of the digital audio signal comprises the following steps:
defining an array to store the sample values of the digital audio signal;
the array format is int audioSamples[BUFFER_SIZE], where BUFFER_SIZE represents the size of the array for caching audio sample values;
using the sample value array of the digital audio signal and the array size as parameters, looping through the array, and calculating the average of the sample values within each window by taking a set window size as the unit;
building a nested loop, which includes an outer loop and an inner loop; controlling the sliding position of the window through the outer loop, and accumulating the sample values within the window and calculating the average through the inner loop; replacing the sample value at the central position of the window with the average.

Specifically, the noise reduction method for preprocessing digital audio signals is a mean filtering algorithm. In the software program, an array is first defined to store the sample values of the audio signals, such as intaudioSamples[BUFFER_SIZE], where BUFFER_SIZE represents the size of the array for caching audio sample values and can be set as the case may be. The function takes the array of the audio sample values and the size of the array as parameters. Within the function, the average of the sample values within each window is calculated by looping through the array and taking a set window size as the unit. The nested loop can be used, where the outer loop controls the sliding position of the window, the inner loop accumulates the sample values within the window to calculate the average, and then the sample value at the central position of the window is replaced with the average.

In this embodiment, the outer loop starts from half of the window size and ends at the array length minus half of the window size, so that each sample point to be filtered is positioned at the center of the window;
the window range of the inner loop is centered on the current outer loop position i, extending to the left and right by windowSize/2 sample points each, where windowSize is the window size for mean filtering.

Specifically, the inner loop accumulates the sample values within the window based on the current window position determined by the outer loop. After the accumulation is complete, the average is calculated, representing the average level of the sample values within the window. The original sample value at the center of the window is replaced with the calculated average, thereby achieving noise reduction for the position. Each sample value in the array that may be positioned at the center of the window is processed in such way that filtering and noise reduction are completed across the entire audio signal.

For example, if the window size is set to 5, when the outer loop reaches the third position of the array, the inner loop accumulates the sample values from positions 1 to 5, calculates the average, and assigns the average to the sample value at the third position. This process continues in the same manner to complete the processing of the entire array.

The implementation codes for the nested loop are as follows:

“/*meanFilter (mean filtering function); audioSamples[ ] (array for storing the sample
values of audio signals); bufferSize (size of audio signal sampling value array); windowSize (size
of mean filtering window)*/
void meanFilter (int audioSamples[ ], int bufferSize, int windowSize) {
//The outer loop controls the sliding position of the window over the audio sample value array,
starting from half of the window size
//ending at the array length minus half of the window size. This ensures that each sample point to
be filter is positioned at the center of the window for calculation.
for (int i= windowSize / 2; i<bufferSize − windowSize / 2; i++) {
int sum =0;
//The inner loop is used to accumulate all audio sample values within the current window. The
window range is centered on the current outer loop position i, extending to the left and right by
windowSize/2 sample points each.
for (int j=i− windowSize / 2; j<=i+ windowSize/ 2; j++){
sum+= audioSamples[j]:
}
//Calculate the average of the sample values within the current window and assign the average to
the sample point currently positioned at the center of the window to achieve mean filtering for the
sample point.
//By continuously sliding the window and repeating this process, filtering is applied to all
appropriate sample points in the entire audio sample value array.
audioSamples[i]=sum/ windowSize;
}”.

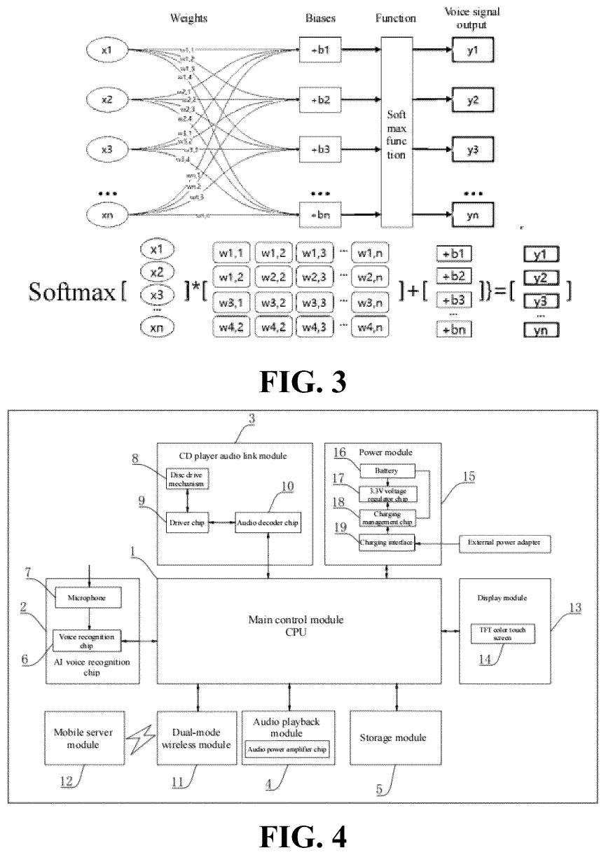

As shown in FIG. 3, in this embodiment, in S3, in the voice recognition model built based on the deep learning algorithm, multiply the output value of the voice input signal by the corresponding weight and add them up, add the corresponding bias value of the voice output signal to the obtained result, and finally obtain the final output result of the voice output signal through an activation function.

The expression of the voice recognition model is as follows:

$$y ( n ) = Softmax ( {\sum }_{i = 1}^{n} {x}_{i} + {b}_{i} ) )$$

where y(n) represents the voice signal output by the model for the n^{th} type, wᵢ is the weight of the voice output signal i, xᵢ is the voice input signal i, and bᵢ is the bias value corresponding to the voice output signal i.

Specifically, when the voice input signal enters the voice recognition model, each voice input signal has its corresponding weight. The voice recognition model multiplies the output value of each voice input signal by its respective weight.

Next, the weighted output values are summed. The result is then added to the bias value corresponding to the voice output signal. Finally, the sum calculated is input into an activation function. The activation function performs a non-linear transformation on the sum, yielding the final output result of the voice output signal. For example, assuming there are three voice input signals with output values A, B and C, corresponding weights a, b and c, and a bias value d, first calculate Aa+Bb+C*c, and then add d. Input the result into the activation function to obtain the final output result. This calculation process enables the voice recognition model to learn and capture complex features and patterns within the voice signals, thereby achieving accurate voice recognition.

As shown in FIG. 4, the embodiment of the invention also provides an AI voice interaction CD player control device, using the AI voice interaction CD player control method in the above embodiment, and comprising a main control module 1, an AI voice recognition module 2, a CD player audio link module 3, an audio playback module 4 and a storage module 5;
the AI voice recognition module 2 comprises a voice recognition chip 6 and a microphone 7, the microphone 7 is electrically connected to the voice recognition chip 6, the voice recognition chip 6 is electrically connected to the main control module 1, the voice recognition chip 6 comprises an offline voice chip and an AI voice chip, and the AI voice recognition module 2 is used to collect the user's voice control commands;
the CD audio link module 3 comprises a disc drive mechanism 8, a driver chip 9 and an audio decoder chip 10; the disc drive mechanism 8 is connected to the driver chip 9, the driver chip 9 is connected to the audio decoder chip 10, and the audio decoder chip 10 is connected to the main control module 1; the disc drive mechanism 8 is used to scan CD disc information via a laser head; the driver chip 9 is used to read audio data; the audio decoder chip 10 is used to decode and convert the read audio data into audio signals;
the audio playback module 4 is connected to the main control module 1, is provided with an audio power amplifier chip and is used to play the original audio signals through the audio power amplifier chip and a speaker configured;
the storage module 5 is connected to the main control module 1 and is used for random access of audio signals obtained from decoded and converted audio data.

In this embodiment, the AI voice interaction CD player control device further comprises a dual-mode wireless module 11, which is connected to the main control module 1 and is used for wireless data transmission and control of the CD player. Moreover, the AI voice interaction CD player control device further comprises a mobile server module 12, which establishes a connection with the main control module 1 through the dual-mode wireless module 11 and enables users to send playback control commands to the CD player via a mobile terminal.

Specifically, the dual-mode wireless module 11 is connected to the main control module 1, enabling wireless data transmission and control of the CD player. Regarding data transmission, the dual-mode wireless module 11 transmits various data between the CD player and external devices (such as smartphones, computers, etc.), such as audio files and device status information. Regarding control, the external devices can utilize the dual-mode wireless module 11 to send control commands to the main control module 1, thereby controlling the CD player.

The mobile server module 12 establishes a connection with the main control module 1 through the dual-mode wireless module 11. When the user operates on a mobile terminal (such as a smartphone), the mobile terminal sends playback control commands to the mobile server module 12. After receiving and processing these commands, the mobile server module 12 transmits them to the main control module 1 via the dual-mode wireless module 11. Based on the received commands, the main control module 1 executes specific operations on the CD player, such as play, pause or track switching. For example, when the user connects the smartphone to the CD player via the dual-mode wireless module 11, he/she can select a CD track to play on the smartphone. The dual-mode wireless module 11 transmits this command to the main control module 1, which then controls the CD player to play the corresponding track.

During voice recognition interaction, the microphone 7 of the device collects and converts voice into a digital signal, and extracts features. The main control module 1 coordinates and processes the data signal, and then sends the feature data to the mobile server module 12 via the dual-mode wireless module 11. The mobile server module 12 compares and matches the data using a trained model, obtains the recognition result, and sends it back to the main control module 1. The main control module 1 analyzes the result and performs corresponding operations or displays based on the result, completing the interaction.

In this embodiment, the AI voice interaction CD player control device further comprises a display module 13, which is equipped with a TFT color touch screen 14, is connected to the main control module 1 and is used to display the music lyric data corresponding to the audio signals played.

Specifically, the display module 13 is connected to the main control module 1. When the CD player plays an audio signal, the main control module 1 acquires and transmits the corresponding music lyric data to the display module 13. After receiving the lyric data from the main control module 1, the TFT color touch screen configured in the display module 13 presents the lyrics clearly and in color through a display driver circuit and a pixel matrix inside it. If the user touches the color screen, the touch signal is sent to the main control module 1. Based on the touch operations (such as page flipping or display content switching), the main control module 1 controls the display module 13 to update the displayed lyric information. For example, during playback, the TFT color touch screen of the display module 13 displays the lyrics of the currently playing line or segment in real time, facilitating users to sing along or review.

In this embodiment, the AI voice interaction CD player control device further comprises a power module 15, which is equipped with a battery 16, a 3.3V voltage regulator chip 17, a charging management chip 18 and a charging interface 19;
the battery 16 is used to supply power to the entire CD player; the charging interface 19 is used to connect an external power adapter to charge the battery 16; the charging management chip 18 is used to regulate the charging process; the 3.3V voltage regulator chip 17 is used to convert the voltage input by the battery 16 or the charging interface 19 into a 3.3V voltage output to supply power to the entire CD player.

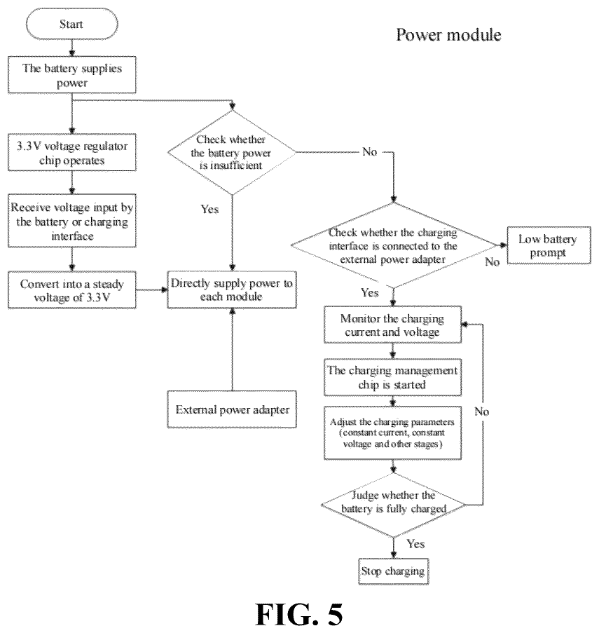

As shown in FIG. 5, specifically, the battery 16 serves as the power source for the entire CD player, supplying the necessary electrical energy to all components of the device to ensure proper operation. When the battery 16 is low, the external power adapter is connected via the charging interface 19. Once current from the external power source is input, the charging management chip 18 begins operating. The charging management chip 18 monitors and regulates the charging process, for example, controlling the charging current and voltage, monitoring the charge level of the battery 16 and preventing overcharging, to ensure the battery 16 is charged safely and efficiently. During device operation, the voltage output by the battery 16 or input via the charging interface 19 may not be a steady 3.3V. At this point, the 3.3V voltage regulator chip 17 converts and stabilizes the input voltage to output a 3.3V voltage, providing a reliable power supply to components requiring 3.3V voltage.

In a possible embodiment, the audio decoder chip 10 of the AI voice recognition module 2 is selected from Silan series such as SC6137D, SC6135B or SC9659P, or Sunplus SPHE8104GW; the driver chip 9 of the CD audio link module 3 is selected from Silan SA1466, SA1461 or SL0311, or Rohm chip; the disc drive mechanism 8 is selected from M93BG6 or DA11; the charging management chip 18 is selected from TP4054, TP4056, TP4057 or TP5000; the radio chip is RDA5807MP.

In a possible embodiment, the audio power amplifier chip is selected from XPT series such as XPT4863, HAA9809S, ESMT series or CS43L21; the battery 16 is 18650 or 21700 lithium battery 16 or polymer lithium battery 16; the voice recognition chip 6 is selected from offline voice chips such as Jieli JL701 series, Jieli AC695 series, MVSILICON series AP8064, Rockchip series RK2108, or AI modules based on Jieli series AC7911B8/BA; the charging interface 19 can be a Type-C interface or other DC jack, with input voltage of 5V/9V/12V; the storage module 5 is selected from WINDAND 25Q series; the dual-mode wireless module 11 is a Wi-Fi+BT integrated module with ESP32 series chip or AP6255 chip, compliant with802.11b/g/n/ac standard, supporting 2.4G and 5G dual bands; the Wi-Fi interface is SDIO, and the Bluetooth interface is a UART serial port.

To sum up, the invention comprises the following steps: calling a microphone 7 for an AI voice recognition module 2 to collect the user's voice signal, and digitizing the collected voice signal into a digital audio signal; preprocessing the digital audio signal, including noise reduction, filtering and framing; extracting voice signal feature parameters for the preprocessed digital audio signal; the voice signal feature parameters include Mel-frequency cepstral coefficient feature vectors and represent the acoustic features of the voice signal; inputting the extracted voice signal feature parameters into a pre-trained voice recognition model built based on a deep learning algorithm, and classifying and recognizing the input voice signal feature parameters through the voice recognition model to generate text control commands for a CD player. When the voice input signals enter the voice recognition model, each voice input signal has its corresponding weight. The voice recognition model multiplies the output value of each voice input signal by its respective weight. Then, these output values multiplied by the weights are summed. The result is added to the bias value corresponding to the voice output signal. Finally, the sum calculated is input into an activation function. The activation function performs a non-linear transformation on the sum, yielding the final output result of the voice output signal. The dual-mode wireless module 11 is connected to the main control module 1, enabling wireless data transmission and control functions for the CD player. Regarding data transmission, the dual-mode wireless module 11 transmits various data between the CD player and external devices (such as smartphones, computers, etc.), such as audio files and device status information. Regarding control, the external devices can utilize the dual-mode wireless module 11 to send control commands to the main control module 1, thereby controlling the CD player. The mobile server module 12 establishes a connection with the main control module 1 through the dual-mode wireless module 11. When the user operates on a mobile terminal (such as a smartphone), the mobile terminal sends playback control commands to the mobile server module 12. After receiving and processing these commands, the mobile server module 12 transmits them to the main control module 1 via the dual-mode wireless module 11. Based on the received commands, the main control module 1 executes specific operations on the CD player, such as play, pause or track switching. For example, when the user connects the smartphone to the CD player via the dual-mode wireless module 11, he/she can select a CD track to play on the smartphone. The dual-mode wireless module 11 transmits this command to the main control module 1, which then controls the CD player to play the corresponding track. The display module 13 is connected to the main control module 1. When the CD player When the CD player plays an audio signal, the main control module 1 acquires and transmits the corresponding music lyric data to the display module 13. After receiving the lyric data from the main control module 1, the TFT color touch screen configured in the display module 13 presents the lyrics clearly and in color through a display driver circuit and a pixel matrix inside it. If the user touches the color screen, the touch signal is sent to the main control module 1. Based on the touch operations (such as page flipping or display content switching), the main control module 1 controls the display module 13 to update the displayed lyric information. For example, during playback, the TFT color touch screen of the display module 13 displays the lyrics of the currently playing line or segment in real time, facilitating users to sing along or review. The battery 16 serves as the power source for the entire CD player, supplying the necessary electrical energy to all components of the device to ensure proper operation. When the battery 16 is low, the external power adapter is connected via the charging interface 19. Once current from the external power source is input, the charging management chip 18 begins operating. The charging management chip 18 monitors and regulates the charging process, for example, controlling the charging current and voltage, monitoring the charge level of the battery 16 and preventing overcharging, to ensure the battery 16 is charged safely and efficiently. During device operation, the voltage output by the battery 16 or input via the charging interface 19 may not be a steady 3.3V. At this point, the 3.3V voltage regulator chip 17 converts and stabilizes the input voltage to output a 3.3V voltage, providing a reliable power supply to components requiring 3.3V voltage. The invention can accurately understand users' voice commands and automatically control playback and recommend music based on users' personalized needs and preferences, meeting their demands for convenient, intelligent and personalized audio experiences.

The invention is described above in detail through general explanations and specific embodiments. It should be understood that conventional adjustments or further innovations can be made to these embodiments based on the technical concept of the invention. However, as long as such adjustments or innovations do not depart from the technical concept of the invention, the resulting technical solutions shall likewise fall within the scope of protection defined by the claims of the invention.

1. An AI voice interaction CD player control method, comprising the following steps:
calling a microphone for an AI voice recognition module to collect the user's voice signal, and digitizing the collected voice signal into a digital audio signal;
preprocessing the digital audio signal, including noise reduction, filtering and framing;
extracting voice signal feature parameters for the preprocessed digital audio signal; the voice signal feature parameters include Mel-frequency cepstral coefficient feature vectors and represent the acoustic features of the voice signal;
inputting the extracted voice signal feature parameters into a pre-trained voice recognition model built based on a deep learning algorithm, and classifying and recognizing the input voice signal feature parameters through the voice recognition model to generate text control commands for a CD player.

2. The AI voice interaction CD player control method according to claim 1, wherein the preprocessing of the digital audio signal comprises the following steps:
defining an array to store the sample values of the digital audio signal;
the array format is int audioSamples[BUFFER_SIZE], where BUFFER_SIZE represents the size of the array for caching audio sample values;
using the sample value array of the digital audio signal and the array size as parameters, looping through the array, and calculating the average of the sample values within each window by taking a set window size as the unit;
building a nested loop, which includes an outer loop and an inner loop; controlling the sliding position of the window through the outer loop, and accumulating the sample values within the window and calculating the average through the inner loop; replacing the sample value at the central position of the window with the average.

3. The AI voice interaction CD player control method according to claim 2, wherein the outer loop starts from half of the window size and ends at the array length minus half of the window size, so that each sample point to be filtered is positioned at the center of the window;
the window range of the inner loop is centered on the current outer loop position i, extending to the left and right by windowSize/2 sample points each, where windowSize is the window size for mean filtering.

4. The AI voice interaction CD player control method according to claim 1, wherein in the voice recognition model built based on the deep learning algorithm, multiply the output value of the voice input signal by the corresponding weight and add them up, add the corresponding bias value of the voice output signal to the obtained result, and finally obtain the final output result of the voice output signal through an activation function.

5. The AI voice interaction CD player control method according to claim 4, wherein the expression of the voice recognition model is as follows:
$$y ( n ) = Softmax ( {\sum }_{i = 1}^{n} ( {w}_{i} {x}_{i} + {b}_{i} ) )$$
where y(n) represents the voice signal output by the model for the n^{th} type, wᵢ is the weight of the voice output signal i, xᵢ is the voice input signal i, and bᵢ is the bias value corresponding to the voice output signal i.

6. An AI voice interaction CD player control device, using the AI voice interaction CD player control method of claim 1, and comprising a main control module (1), an AI voice recognition module (2), a CD player audio link module (3), an audio playback module (4) and a storage module (5);
the AI voice recognition module (2) comprises a voice recognition chip (6) and a microphone (7), the microphone (7) is electrically connected to the voice recognition chip (6), the voice recognition chip (6) is electrically connected to the main control module (1), the voice recognition chip (6) comprises an offline voice chip and an AI voice chip, and the AI voice recognition module (2) is used to collect the user's voice control commands;
the CD audio link module (3) comprises a disc drive mechanism (8), a driver chip (9) and an audio decoder chip (10); the disc drive mechanism (8) is connected to the driver chip (9), the driver chip (9) is connected to the audio decoder chip (10), and the audio decoder chip (10) is connected to the main control module (1); the disc drive mechanism (8) is used to scan CD disc information via a laser head; the driver chip (9) is used to read audio data; the audio decoder chip (10) is used to decode and convert the read audio data into audio signals;
the audio playback module (4) is connected to the main control module (1), is provided with an audio power amplifier chip and is used to play the original audio signals through the audio power amplifier chip and a speaker configured;
the storage module (5) is connected to the main control module (1) and is used for random access of audio signals obtained from decoded and converted audio data.

7. The AI voice interaction CD player control device according to claim 6, further comprising a dual-mode wireless module (11), which is connected to the main control module (1) and is used for wireless data transmission and control of the CD player.

8. The AI voice interaction CD player control device according to claim 7, further comprising a mobile server module (12), which establishes a connection with the main control module (1) through the dual-mode wireless module (11) and enables users to send playback control commands to the CD player via a mobile terminal;
the mobile server module (12) utilizes a trained voice recognition model based on a deep learning algorithm for comparison and matching, generates and transmits recognition results to the main control module (1); the main control module (1) analyzes the recognition results and performs corresponding operations or displays based on the analysis results, thereby completing the interaction.

9. The AI voice interaction CD player control device according to claim 1, further comprising a display module (13), which is equipped with a TFT color touch screen (14), is connected to the main control module (1) and is used to display the music lyric data corresponding to the audio signals played.

10. The AI voice interaction CD player control device according to claim 6, further comprising a power module (15), which is equipped with a battery (16), a 3.3V voltage regulator chip (17), a charging management chip (18) and a charging interface (19);
the battery (16) is used to supply power to the entire CD player; the charging interface (19) is used to connect an external power adapter to charge the battery (16); the charging management chip (18) is used to regulate the charging process; the 3.3V voltage regulator chip (17) is used to convert the voltage input by the battery (16) or the charging interface (19) into a 3.3V voltage output to supply power to the entire CD player.
